(19) United States
(12) Patent Application Publication
(10) Pub. No.: US 2026/0277832 A1
(43) Pub. Date: Sep. 17, 2026

(54) ON DIE TERMINATION CONTROL IN FLASH MEMORY

(71) Applicant: Silicon Motion, Inc., Hsinchu County (TW)

(72) Inventor: Shiuan-Hao Kuo, Hsinchu County (TW)

(73) Assignee: Silicon Motion, Inc., Hsinchu County (TW)

(21) Appl. No.: 19/079,413

(22) Filed: Mar. 13, 2025

(51) Int. Cl. G06F 13/16; G06F 13/362

(52) U.S. Cl. CPC G06F 13/1689; G06F 13/1642; G06F 13/362

(57) ABSTRACT

A method for controlling a plurality of logical units of a flash memory includes: transmitting on-die termination (ODT) enabling control information over a control bus corresponding to the plurality of logical units through a data transmission start command to enable ODT operation of one or more non-target logical units; and transmitting ODT disabling control information over the control bus through a data transmission terminate command or a data transmission pause command to disable ODT operation of the one or more non-target logical units.

### BACKGROUND OF THE INVENTION

### 1. Field of the Invention

The present invention relates to flash memory, and more particularly to a method for controlling logical units of a flash memory with enhanced on-die termination control and a related memory controller and data storage device.

### 2. DESCRIPTION OF THE PRIOR ART

In modern NAND flash memory devices, efficient communication between the memory controller and flash memory units is crucial. Traditional parallel interfaces, while functional, require numerous pins and may face signal integrity challenges at high speeds. As NAND flash memory devices continue to evolve with higher densities and faster operating speeds, there is an increasing need for more efficient command and data transmission protocols.

Separate-Command-Address (SCA) Protocol has emerged as a solution to address these challenges in NAND flash memory devices. This protocol defines the communication interface between the memory controller and NAND flash memory units, providing a streamlined approach for command transmission and data transfer.

However, existing implementations of the SCA Protocol may face limitations in terms of command efficiency and latency optimization. As NAND flash applications become more demanding, particularly in enterprise storage systems and high-performance computing environments, there is a growing need for enhanced protocol features that can better support advanced operations.

### SUMMARY OF THE INVENTION

With this in mind, it is one object of the present invention to provide on-die termination control mechanism. Specifically, the present invention relies on a data burst start command embedded with on-die termination enabling control information to enable on-die termination of non-target logical units, while relies on a data burst terminate command or a data burst pause command embedded with on-die termination disabling control information to disable on-die termination of non-target logical units. In embodiments of the present invention, the data burst start command embedded with on-die termination enabling control information could be a select chip enable (SCE) packet defined in SCA protocol, where reserved bits in the SCE packet is used to carry on-die termination enabling control information. Moreover, the data burst terminate command or the data burst pause command embedded with on-die termination disabling control information could be a select chip terminate (SCT) packet or a select chip pause (SCP) packet defined in SCA protocol, wherein reserved bits in the SCT or SCP packet is used to carry on-die termination disabling control information. By embedded on-die termination control information into the existing the data burst start command and the data burst terminate/pause command, the effectively of the on-die termination control can be improved.

According to one embodiment, a method for controlling a plurality of logical units of a flash memory is provided. The method comprises: transmitting on-die termination (ODT) enabling control information over a control bus corresponding to the plurality of logical units through a data transmission start command to enable ODT operation of one or more non-target logical units; and transmitting ODT disabling control information over the control bus through a data transmission terminate command or a data transmission pause command to disable ODT operation of the one or more non-target logical units.

According to one embodiment, a memory controller for controlling a plurality logical units in a flash memory is provided. The memory controller comprises: a storage unit and a processing unit. The storage unit is configured to store program codes. The processing unit is configured to execute the program code to perform operations on the flash memory, comprising: transmitting an on-die termination (ODT) enabling control information over a control bus corresponding to the plurality of logical units through a data transmission start command to enable ODT operation of one or more non-target logical units; and transmitting an ODT disabling control information over the control bus through a data transmission terminate command or a data transmission pause command to disable ODT operation of the one or more non-target logical units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an electronic device and a data storage device according to one embodiment of the present invention.

FIG. 2 illustrates how a memory controller manages and controls logical units of NV memory with chip enablement control.

FIG. 3 illustrates structure of a SCE packet.

FIG. 4 illustrates structure of a SCT or SCP packet.

FIG. 5A illustrates a timing chart of non-target ODT control according to one embodiment of the present invention.

FIG. 5B illustrates a timing chart of non-target ODT control according to another one embodiment of the present invention.

FIG. 6 illustrates a flow chart of a method for controlling logical units of flash memory according to one embodiment of the present invention.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

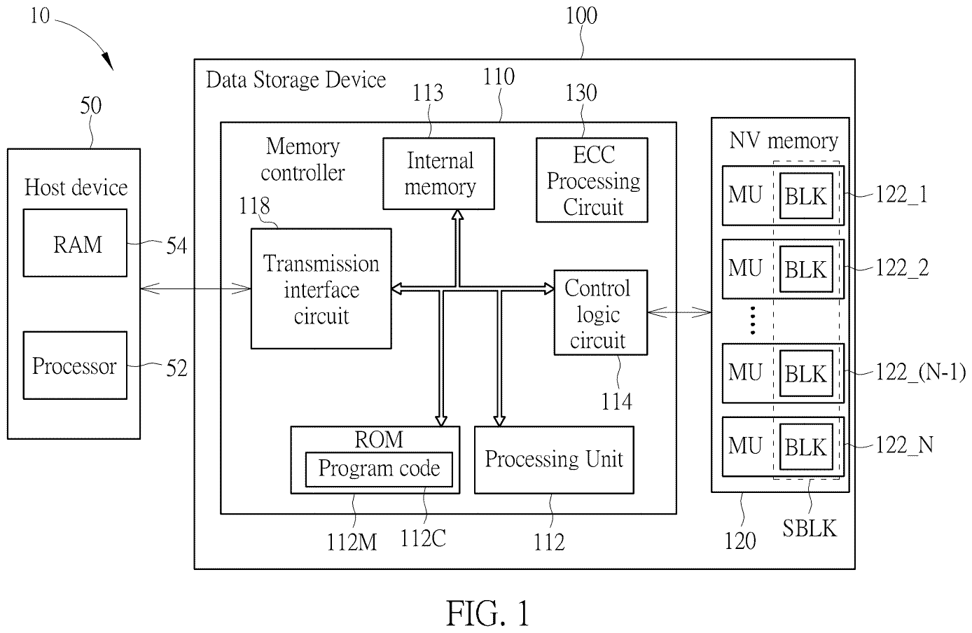

FIG. 1 is a schematic diagram illustrating an electronic device and a data storage device according to one embodiment of the present invention. As illustrated an electronic device 10 comprises a host device 50 and a data storage device 100. The host device 50 may comprise: at least one processor 52 configured to control operations of the host device 50, and a random access memory 54 configured to store data and information required by the processor 52. Examples of the host device 50 may include, but are not limited to: a smartphone, a tablet computer, a wearable device, a personal computer (such as, a desktop computer or a laptop computer), an imaging device (such as, a digital still camera or a video camera), a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a memory controller 110 and may further comprise a non-volatile (NV) memory 120. The NV memory 120 may comprise one or more NV memory elements, such as a plurality of NV memory elements (MU) 122_1-122_N. For example, the NV memory 120 may be a NAND flash memory, and the NV memory elements 122_1-122_N may be a plurality of NAND flash memory packages or a plurality of NAND flash memory dies, respectively, but the present invention is not limited thereto.

In some embodiments, the NV memory 120 may include a plurality of memory blocks BLK, which may be grouped into a plurality of superblocks SBLK. The memory block BLK may refer to a physical block and includes a plurality of memory cells. The superblock SBLK may be a unit of a logical memory region required for the memory controller 110 to manage the NV memory, where a composition of a superblock SBLK can span across NV memory chips 122_1-122_N. The memory block BLK may be implemented as a memory cell array in which a plurality of memory cells form a two-dimensional (2D) or three-dimensional (3D) array structure. The plurality of memory cells may be single-level cells programmed with one bit information or multi-level cells (e.g., double-level cells, triple-level cells or quadruple-level cells) programmed with two bits or more bits information. Moreover, the memory block BLK may include a plurality of pages, where memory cells connected to a same word line may constitute a page. For example, the memory block BLK may be a smallest erasable unit, and the page may be the smallest addressable unit for read and program operations.

In some embodiments, each of NV memory units 122_1-122_N is equipped with control circuitry for executing memory operation commands issued by the memory controller 110. Each of NV memory dies 122_1-122_N may include multiple planes, where each plane may have multiple blocks composed of memory cells, along with associated row and column control circuitry. Through multi-plane operation commands, various memory operations can be applied parallel on different planes to perform multi-plane reading, writing or erasing operations.

Moreover, the NV memory 120 may contain one or more targets.

A target is controlled by one chip enable signal (e.g., CE_n). A target is organized into one or more logical units (LUNs). A logical unit (LUN) is the minimum unit that can independently execute commands and report status. Specifically, separate LUNs may operate on arbitrary command sequences in parallel. For example, it is permissible to start a page program operation on a first LUN and then prior to the operation's completion to start a read command on a second LUN. A LUN contains at least one page register and a flash array. The number of page registers is dependent on the number of multi-plane operations supported for that LUN. The flash array contains a number of blocks, and a block contains a number of pages. A page consists of a number of bytes or words. Each LUN shall have at least one page register. A page register is used for the temporary storage of data before it is moved to a page within the flash array or after it is moved from a page within the flash array. The byte or word location within the page register is referred to as the column. There are two mechanisms to achieve parallelism within this architecture. There may be multiple commands outstanding to different LUNs at the same time. To get further parallelism within a LUN, multi-plane operations may be used to execute additional dependent operations in parallel.

The memory controller 110 may comprise a processing unit 112, a read-only memory (ROM) 112M, an internal memory 113, a transmission interface circuit 118, an error checking and correction (ECC) processing circuit 130. At least one portion of these circuits and components may be coupled to one another through a bus. The internal memory 113 can be implemented by one or more RAM devices. For example, the internal memory 113 may comprise a static RAM (SRAM) and/or a dynamic RAM (DRAM). The internal memory 113 could be configured to provide internal storage space for the memory controller 110, for example, temporarily storing information, such as data, addresses, commands, mapping information, and/or variables/parameters. In some embodiments, the memory controller 110 may not include DRAM. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100.

In addition, the ROM 112M in this embodiment is configured to store program code 112C, and the microprocessor 112 is configured to execute the program code 112C, thereby controlling access to the NV memory 120. The program code 112C may include one or more program modules, such as boot loader code. When the data storage device 100 obtains power from the host device 50, the processing unit 112 may execute an initialization process of the data storage device 100 by executing the program code 112C. During the initialization process, the microprocessor 112 may load a set of in-system programming (ISP) codes (not shown in FIG. 1) from the NV memory 120. The microprocessor 112 can execute the ISP codes so that the data storage device 100 can be operable to perform various functions. According to one embodiment of the present invention, the set of ISP codes may include, but are not limited to: one or more program modules associated with memory access (e.g., reading, writing, and erasing), such as, a read operation module, a lookup table module, a wear leveling module, a read refresh module, a read reclaim module, and a garbage collection module, an sudden power-off recovery(SPOR) module, which are provided to perform corresponding reading, lookup table querying, wear leveling, read refreshing, read reclaiming, garbage collection, SPOR and other operations.

The memory controller 110 controls reading, writing, and erasing of the NV memory 120 through a flash control circuit 150. In addition, the memory controller 110 could perform writing of data based on host commands from the host device 50 and writing of valid data which is read from the NV memory 120 by a garbage collection and/or a wear-leveling operation concurrently. The transmission interface circuit 118 may conform to a specific communications specification, such as, Universal Serial Bus (USB) specification, Secure Digital (SD) interface, Ultra High Speed-I (UHS-I) interface, Ultra High Speed-II (UHS-II), CompactFlash (CF) interface, Multimedia card (MMC) interface, embedded Multimedia Card (eMMC) specification, Advanced Technology Attachment (ATA), Serial Advanced Technology Attachment (SATA), Parallel Advanced Technology Attachment (PATA), Peripheral Component Interconnect Express (PCI-E), and Universal Flash Storage (UFS) specification, and may perform communications with the host device 50 according to the specific communications specification.

Typically, the host device 50 may indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120.

In some embodiments, a logical-to-physical (L2P) address mapping table having multiple L2P address mapping entries, can be divided into multiple mapping groups. Each mapping group includes a part of entries of the L2P address mapping table and is utilized for performing logical-to-physical address translation. These L2P mapping groups are permanently stored in blocks of NV memory 120 and are loaded into the internal memory 113 when needed. Similarly, a physical-to-logical (P2L) address mapping table having multiple P2L address mapping entries, can be divided into multiple mapping groups. Each mapping group includes a part of entries of the P2L address mapping table and is utilized for performing physical to logical address translation. These P2L mapping groups are permanently stored in blocks of NV memory 120.

Typically, the memory controller 110 utilizes chip enable signal to control enablement of the NV memory units 122_1-122_N. When the memory controller 110 requires to communicate to a target NV memory unit for executing access operations, a chip enable signal corresponding to the target NV memory unit would be active, permitting active operation including input and/or output of data of the target memory unit, while chip enable signals corresponding other (i.e., non-target) NV memory units would be inactive, preventing active operation and causing these NV memory units to be in a reduced power standby mode with their outputs floating.

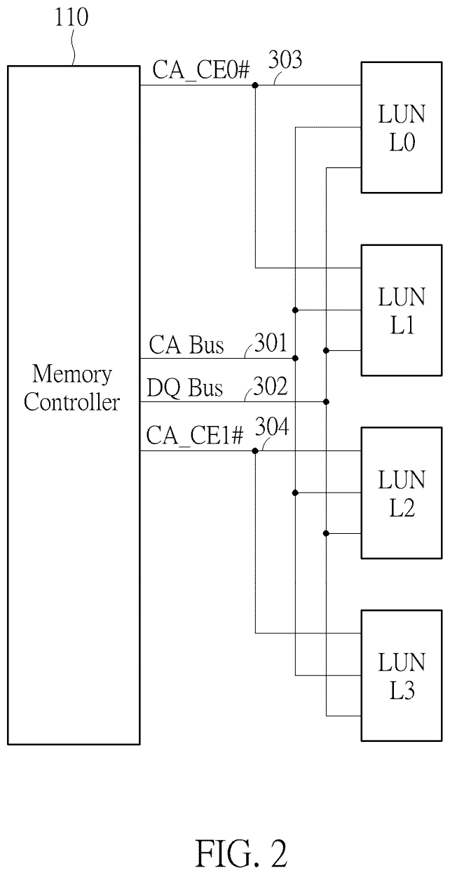

FIG. 2 illustrates how the memory controller 110 manages and controls logical units (LUNs) of the NV memory 120 with chip enablement control based on Separate-Command-Address (SCA) protocol. In this example, the memory controller 110 is configured to control LUNs L0-L3, through a command/address (CA) bus 301, a data input/output (DQ) bus 302, a first CA bus enable signal (e.g., a “CA_CE0#” signal) 303 and a second CA bus enable signal (e.g., a “CA_CE1#” signal) 304. Please note that the number of LUNs and the number of bus enable signals mentioned above are just for illustrative purposes.

Specifically, the first CA bus enable signal 303 is configured to enable the CA bus 301 for the LUN L0 and the LUN L1, while the second CA bus enable signal 304 is configured to enable the CA bus 301 for the LUN L2 and the LUN L3. When the first CA bus enable signal 303 is active (which is active low), the LUN L0 and the LUN L1 are permitted to respond to control signals/commands and addresses over the CA bus 301. Similarly, when the second CA bus enable line 304 is active, the LUN L2 and the LUN L3 are permitted to respond to control signals/commands and addresses over the CA bus 301.

In addition, the NV memory 120 also implements an on-die termination (ODT), which is configured to improve signal integrity on the DQ bus 302 by allowing the memory controller 110 to independently turn on/off termination resistance for any or all logical units in the NV memory 120. This because data transactions between the memory controller 110 and the LUNs L0-L3 relies on the shared DQ bus 302. In order to prevent data signals from being interfered by reflection from non-target LUNs, ODT of non-target LUNs can be selectively enabled on the DQ bus 302 to adjust ODT behaviors of specific non-target LUNs based on system requirements.

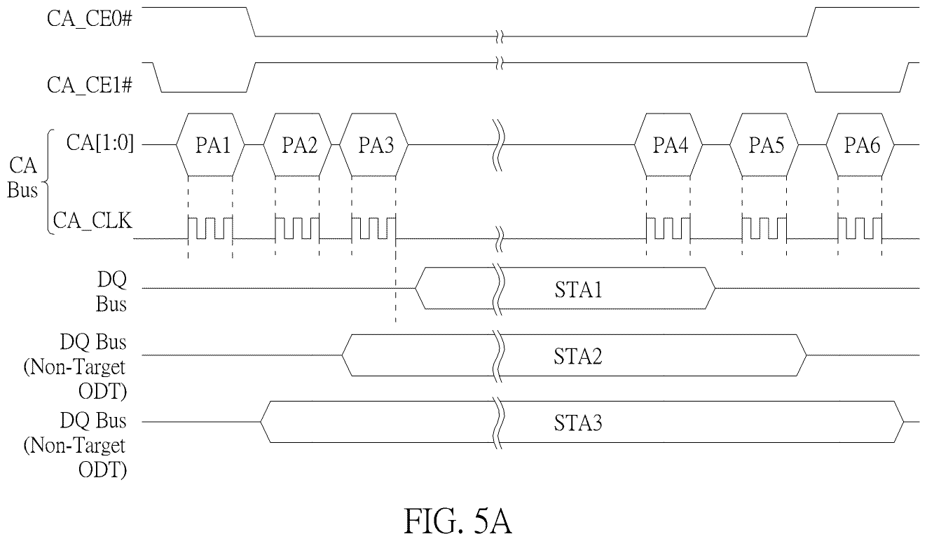

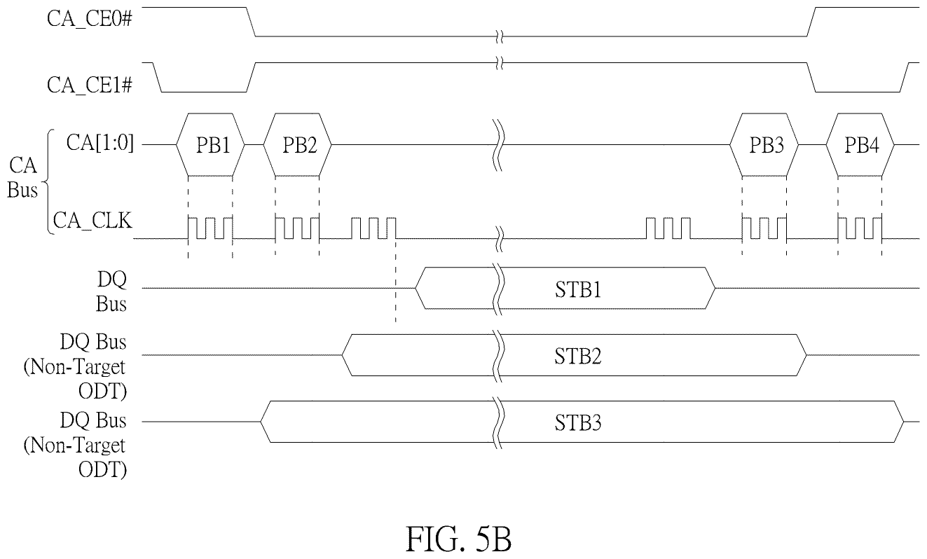

In particular, the memory controller 110 would send ODT enabling control information and ODT disabling control information to the LUNs, thereby to enable or disable the ODT operation of the non-target LUNs. In some embodiments, the ODT enabling control information and ODT disabling control information can be implemented by issuing non-target ODT (NTO) packets over the CA bus 301. Please refer to FIG. 2 in conjunction with FIG. 5A for further understanding, wherein FIG. 5A illustrates a timing chart of non-target ODT control mechanism according to one embodiment of the present invention. In the embodiment shown by FIG. 5A, it is assumed that a target LUN for accessing is LUN L0 in the example of FIG. 2. To enable the non-target ODT operation on the DA bus 302, the memory controller 110 would first issue a first type of NTO packet PA1 over the CA bus 301 to instruct those LUNs controlled by one or more bus enable signals that do not correspond to the target LUN to enable the ODT. In this embodiment, since the target LUN for accessing is LUN L0, which means the first type of NTO packet PA1 is used to instruct the LUN L2 and the LUN L3 controlled by the bus enable signal CA_CE1# that does not correspond to the target LUN L0. As shown by FIG. 5A, when the second bus enable signal CA_CE1# is active (which is active low), the LUN L2 and the LUN 3 would receive and respond to the first type of NTO packet PA1, thereby to enable the ODT operation of the LUN L2 and the LUN 3 to provide ODT on the DQ bus 302(i.e., the state STA3).

Then, the memory controller 110 would issue a second type of NTO packet PA2 over the CA bus 301 to instruct those LUNs controlled by a same bus enable signal as the target LUN, to enable the ODT operation on the DA bus 302, wherein the second type of NTO packets further include address information regarding LUNs that need to enable ODT operation. Since the target LUN for accessing is LUN L0, which means the second type of NTO packet PA2 is used to instruct the LUN L1 to enable the ODT. As shown, when the first bus enable signal CA_CE0# is active (which is active low), the LUN L0 and the LUN 1 would receive the second type of NTO packet PA2. As the LUN 1 is addressed by the second type of NTO packet PA2, the ODT operation of the LUN L1 would be enabled to provide ODT on the DQ bus 302 (i.e., the state STA2) in response to the second type of NTO packet PA2.

After the first and second types of NTO packets PA1 and PA2 successfully instruct the non-target LUNs to enable the ODT, the memory controller 110 would issue the select chip enable (SCE) packet PA3 over the CA bus 301 to instruct the target LUN L0 for staring or resuming a data burst operation, thereby to input or output data over the DQ bus 302 (i.e., the state STA1). After the data burst operation is completed or when the data burst operation needs to be paused, the memory controller 110 would issue the select chip terminate (SCT) or the select chip pause (SCP) packet PA4 over the CA bus 301 to instruct the target LUN L0 for ceasing or pausing the data burst operation on the DQ bus 302 (i.e., ending of the state STA1).

In addition, the memory controller 110 would issue a third type of NTO packet PA5 over the CA bus 301 to instruct those LUNs controlled by a same bus enable signal as the target LUN, wherein the third type of NTO packets include address information regarding LUNs that need to disable the ODT operation. In the example, the third type of NTO packet PA5 is used to instruct the LUN L1 to disable the ODT operation. In response to the third type of NTO packet PA5, the LUN L1 would disable the ODT operation on the DQ bus 302 (i.e., ending of the state STA2). Then, the memory controller 110 would issue a fourth type of NTO packet PA6 over the CA bus 301 to instruct those LUNs controlled by one or more bus enable signals that do not correspond to the target LUN to disable the ODT operation. That is, the fourth type of NTO packet PA6 is used to instruct the LUN L2 and the LUN L3 to disable the ODT operation on the DQ bus 302 (i.e., ending of the state STA3).

In this embodiment, the number of the second type of NTO packets

PA2 (for enabling the ODT operations of those non-target LUNs controlled by a same bus enable signal as the target LUN) and the number of the third type of NTO packets PA5 (for disabling the ODT operations of those non-target LUNs controlled by a same bus enable signal as the target LUN) issued by the memory controller 110 would significantly increases with the number of those non-target LUNs that are controlled by the same bus enable signal as the target LUN. In the above embodiment, since the number of non-target LUNs that are controlled by the same bus enable signal CA_CE0# as the target LUN L0 is “1” (i.e., LUN L1), the memory controller 110 only needs to issue one NTO packet PA2 and one NTO packet PA5. However, if the bus enable signal CA_CE0# is designed to control more LUNs, such as four LUNs, the memory controller 110 needs to issue the three NTO packets PA2 and three NTO packets PA5 to control ODT operations of these non-target LUNs. This approach becomes increasingly inefficient as the number of LUNs sharing a bus enable signal grows.

In order to provide the efficiency of non-target ODT control, the present invention provides another approach to implement transmission of ODT enabling control information and ODT disabling control information. In one embodiment, the memory controller 110 would use SCE packet to transmit the ODT enabling control information to non-target LUNs that are controlled by a same bus enable signal as the target LUN, thereby instructing them to enable the ODT operation. In one embodiment, the memory controller 110 would use SCT or SCP packet to transmit the ODT disabling control information to non-target LUNs that are controlled by a same bus enable signal as the target LUN, thereby instructing them to disable the ODT operation.

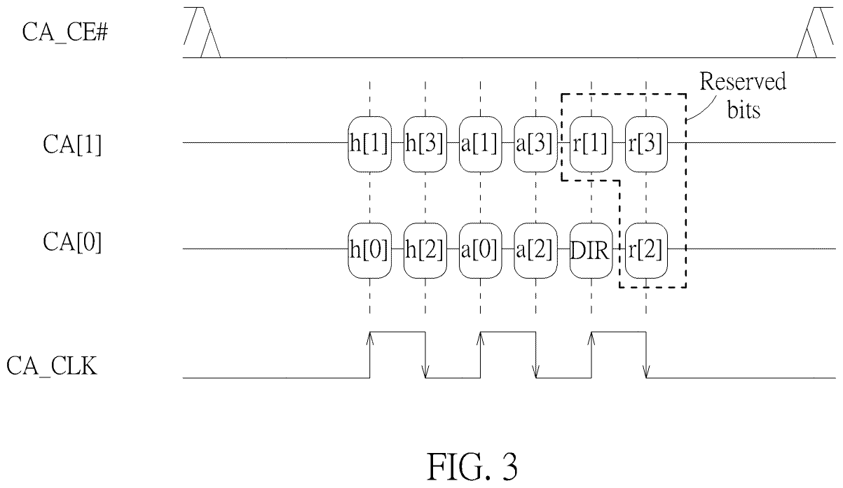

FIG. 3 illustrates structure of a typical SCE packet. As illustrated, the SCE packet contains: header bits h[0]-h[3] indicating the current packet type is to start or resume a data burst operation on the DQ bus; address bits a[0]-a[3] indicating a LUN address of a target LUN; a burst direction bit DIR indicating a direction of the data burst operation; and reserved bits r[1]-r[3]. In one embodiment, the memory controller 110 is configured to set a value of at least one first bit of reserved bits r[1]-r[3] to indicate an enablement state of the ODT operation (e.g., serving as an enabling bit NTEN). In addition, the memory controller 110 is further configured to set a value of at least one second bit of the reserved bits r[1]-r[3] in the SCE packet to indicate a direction of the data burst operation (e.g., serving as a burst direction bit NTDIR), thereby to indicate to enable the ODT on the DQ bus 302 for data input burst or data output data burst. Through the SCE packet embedded with ODT enabling control information (i.e., those bits set in the reserved bits r[1]-r[3] for indicating the enablement state and the burst direction), the ODT operation of the non-target LUNs that are controlled by the same bus enable signal as the target LUN can be properly enabled.

Specifically, when the non-target LUNs that are controlled by the same bus enable signal as the target LUN receive the SCE packet embedded with ODT enabling control information, the non-target LUNs would parse address bits a[0]-a[3] to determine the LUN address of the target LUN. Once the non-target LUNs detects that they are not addressed by the LUN address of the target LUN, the non-target LUNs would further parse reserved bits r[1]-r[3] to determine whether to enable the ODT operation based on the embedded ODT enabling control information.

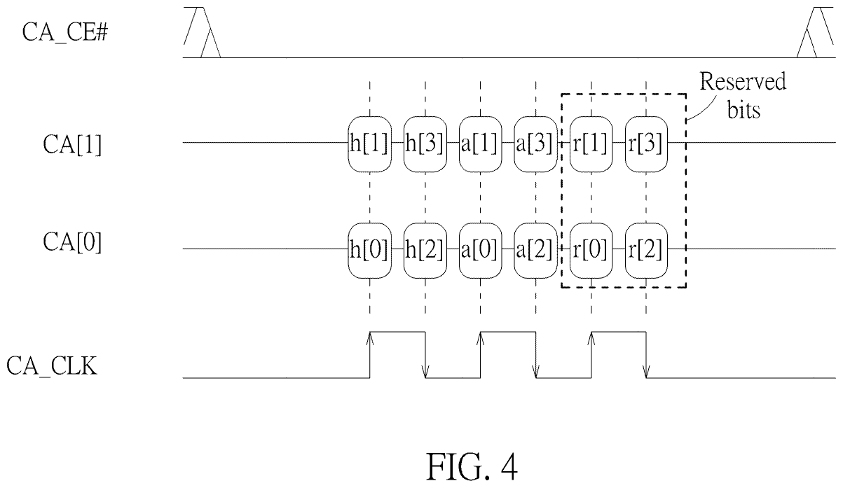

FIG. 4 illustrates structure of a typical SCT or SCP packet. As illustrated, the SCT or SCP packet contains: header bits h[0]-h[3] indicating the current packet type is to terminate or pause an on-going data burst operation on the DQ bus 302; address bits a[0]-a[3] indicating a LUN address of a target LUN; and reserved bits r[0]-r[3]. In one embodiment, the memory controller 110 is configured to set a value of at least one first bit of reserved bits r[0]-r[3] of in the SCT or the SCP to indicate an disablement state of the ODT operation (e.g., serving as an enabling bit NTEN). Optionally, the memory controller 110 is further configured to set a value of at least one second bit of the reserved bits r[0]-r[3] in the SCT or the SCP packet to indicate a direction of an on-going data burst operation (e.g., serving as a burst direction bit NTDIR), thereby to indicate to disable the ODT on the DQ bus 302 for data input burst or data output data burst. Through the SCT or the SCP packet embedded with ODT disabling control information (i.e., those bits set in the reserved bits r[0]-r[3] for indicating the disablement state and optionally the burst direction), the ODT operation of the non-target LUNs that are controlled by a same bus enable signal as the target LUN can be properly disabled.

Specially, when the non-target LUNs that are controlled by the same bus enable signal as the target LUN receive the SCT or SCP packet embedded with ODT disabling control information, the non-target LUNs would parse address bits a[0]-a[3] to determine the LUN address of the target LUN. Once the non-target LUNs detects that they are not addressed by the LUN address of the target LUN, the non-target LUNs would further parse reserved bits r[0]-r[3] to determine whether to disable the ODT operation based on the embedded ODT disabling control information.

Please refer to FIG. 2 in conjunction with FIG. 5B for further understanding, where FIG. 5B illustrates a timing chart of non-target ODT control mechanism according to one embodiment of the present invention. At first, the second bus enable signal CA_CE1# will be set as active (which is active low), which would enable the CA bus 301 for the LUN L2 and the LUN 3. Accordingly, the LUN L2 and the LUN L3 would receive and respond to the NTO packet PB1 issued by the memory controller 110, thereby to enable the ODT operation of the LUN L2 and the LUN 3 to provide ODT on the DQ bus 302 (i.e., the state STB3).

Afterwards, the second bus enable signal CA_CE1# will be set as inactive and the first bus enable signal CA_CE0# will be set as active (which is active low), which would enable the CA bus 301 for the LUN L0 and the LUN L1. Accordingly, the LUN L0 and the LUN L1 would receive and respond to the SCE packet embedded with ODT enabling control information PB2 issued by the memory controller 110. For the target LUN L0, it would start or resume a data burst operation on the DQ bus 302 (i.e., the state STB1). For the non-target LUN L1, it would detect that it is not addressed by the LUN address contained in the SCE packet. Therefore, the non-target LUN L1 would parse reserved bits in the SCE packet and respond to the ODT enabling control information (e.g., enablement state and burst direction) indicated by specific ones of the reserved bits in SCE packet, thereby enabling the ODT operation to provide ODT on the DQ bus 302 (i.e., the state STB2).

On other hand, once the on-going data burst operation is completed or needs to be paused, the memory controller 110 would issue the SCT or SCP packet embedded with ODT disabling control information over the CA bus 302. As the first bus enable signal CA_CE0# remains active, the LUN L0 and the LUN L1 would receive and respond to the SCE packet embedded with ODT disabling control information PB3 issued by the memory controller 110. For the target LUN L0, it would terminate or pause the on-going data burst operation on the DQ bus 302 (i.e., ending of the state STB1). For the non-target LUN L1, it would detect that it is not addressed by the LUN address contained in the SCT or SCP packet. Therefore, the non-target LUN L1 would parse reserved bits in the SCT or STP packet and respond to the ODT disabling control information (e.g., disablement state and/or burst direction) indicated by the reserved bits in the SCT or SCP packet, thereby disabling the ODT operation on the DQ bus 302 (i.e., ending of the state STB2).

At last, the second bus enable signal CA_CE1# will be set as active and the first bus enable signal CA_CE0# will be set as inactive, which would enable the CA bus 301 for the LUN L2 and the LUN L3. Accordingly, the LUN L2 and the LUN L3 would receive and respond to the NTO packet PB4 issued by the memory controller 110, thereby to disable the ODT operation on the DQ bus 302 (i.e., ending of the state STB3).

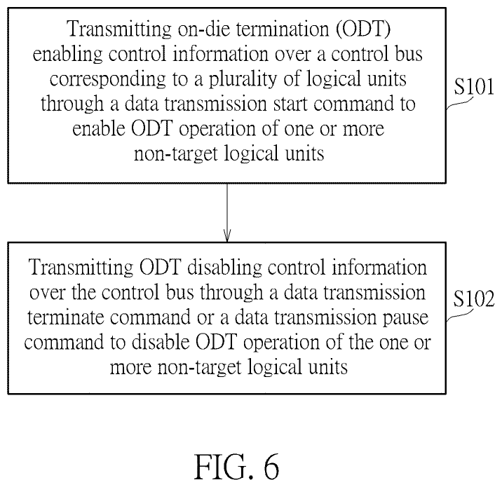

FIG. 6 illustrates a flow chart of a method for controlling a plurality of logical units of a flash memory with enhanced on-die termination control mechanism according to one embodiment of the present invention. As shown in the figure, the method includes the following steps:

Step S101: transmitting on-die termination (ODT) enabling control information over a control bus corresponding to the plurality of logical units through a data transmission start command to enable ODT operation of one or more non-target logical units; and

Step S102: transmitting ODT disabling control information over the control bus through a data transmission terminate command or a data transmission pause command to disable ODT operation of the one or more non-target logical units.

Since the principle and specific details of the foregoing steps have been described expressly in the above embodiments, further descriptions will not be repeated here. It should be noted that the above flow may achieve better performance of the flash memory by adding other extra steps or making appropriate modifications and/or adjustments.

Please note that while the above embodiments describe embedding ODT enabling control information in SCE packets and ODT disabling control information in SCT or SCP packets for SDA protocol, the present invention is not limited to these specific implementations. The ODT control information may be embedded in any suitable command packets that are used for managing data transmission between the memory controller and the memory device. For example, the ODT enabling control information may be embedded in, but not limited to: data transmission start commands, data transfer initiation commands, read/write preparation commands, or any commands that signal start of transfer operations used in various communication protocols. Similarly, the ODT disabling control information may be embedded in, but not limited to: data transmission terminate commands, data transmission pause commands, transfer completion commands, or any commands that signal end or temporary suspension of data transfer operations used in various communication protocols.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a plurality of logical units of a flash memory, comprising:
transmitting on-die termination (ODT) enabling control information over a control bus corresponding to the plurality of logical units through a data transmission start command to enable ODT operation of one or more non-target logical units; and
transmitting ODT disabling control information over the control bus through a data transmission terminate command or a data transmission pause command to disable ODT operation of the one or more non-target logical units.

2. The method of claim 1, wherein the data transmission start command is a select chip enable (SCE) packet defined in Separate-Command-Address (SCA) protocol, the data transmission terminate command is a select chip terminate (SCT) packet defined in SCA protocol, and the data transmission pause command is a select chip pause (SCP) packet defined in SCA protocol.

3. The method of claim 2, wherein the step of transmitting the ODT enabling control information comprises:
setting a value of at least one first bit of reserved bits in the SCE packet to indicate an enablement state of the ODT operation; and
setting a value of at least one second bit of the reserved bits in the SCE packet to indicate to a direction of a data burst operation that the ODT operation is enabled for.

4. The method of claim 3, further comprising:
setting address bits in the SCE packet to indicate a logical unit address of a target logical unit.

5. The method of claim 2, wherein the step of transmitting the ODT disabling control information comprises:
setting a value of at least one first bit of reserved bits in the SCT packet or the SCP packet to indicate a disablement state of the ODT operation.

6. The method of claim 5, further comprising:
setting address bits in the SCT packet or the SCP packet to indicate a logical unit address of a target logical unit.

7. The method of claim 1, further comprising:
enabling the ODT operation of the one or more non-target logical units in response to the ODT enabling control information, wherein the one or more non-target logical units are controlled by a same bus enable signal as a target logical unit.

8. The method of claim 1, further comprising:
disabling the ODT operation of the one or more non-target logical units in response to the ODT disabling control information, wherein the one or more non-target logical units are controlled by a same bus enable signal as a target logical unit.

9. A memory controller for controlling a plurality logical units in a flash memory, comprising:
a storage unit configured to store program codes; and
a processing unit configured to execute the program code to perform operations on the flash memory, comprising:
transmitting an on-die termination (ODT) enabling control information over a control bus corresponding to the plurality of logical units through a data transmission start command to enable ODT operation of one or more non-target logical units; and
transmitting an ODT disabling control information over the control bus through a data transmission terminate command or a data transmission pause command to disable ODT operation of the one or more non-target logical units.

10. The memory control of claim 9, wherein the data transmission start command is a select chip enable (SCE) packet defined in Separate-Command-Address (SCA) protocol, the data transmission terminate command is a select chip terminate (SCT) packet defined in SCA protocol, and the data transmission pause command is a select chip pause (SCP) packet defined in SCA protocol.

11. The memory control of claim 10, wherein when executing the program
codes, the memory controller is configured to:
set a value of at least one first bit of reserved bits in the SCE packet to indicate an enablement state of the ODT operation; and
set a value of at least one second bit of the reserved bits in the SCE packet to indicate a direction of a data burst operation.

12. The memory control of claim 11, wherein when executing the program
codes, the memory controller is configured to:
set address bits in the SCE packet to indicate a logical unit address of a target logical unit.

13. The memory control of claim 10, wherein when executing the program
codes, the memory controller is configured to:
set a value of at least one first bit of reserved bits in the SCT packet or the SCP packet to indicate a disablement state of the ODT operation.

14. The memory control of claim 13, wherein when executing the program
codes, the memory controller is configured to:
set address bits in the SCT packet or the SCP packet to indicate a logical unit address of a target logical unit.

15. The memory control of claim 9, wherein the ODT operation of the one or more non-target logical units are enabled in response to the ODT enabling control information, and the one or more non-target logical units are controlled by a same bus enable signal as a target logical unit.

16. The memory control of claim 9, wherein the ODT operation of the one or more non-target logical units are disabled in response to the ODT disabling control information, and the one or more non-target logical units are controlled by a same bus enable signal as a target logical unit.

17. A data storage device comprising a flash memory and the memory controller of claim 9.
